(19) United States
(12) Patent Application Publication
(10) Pub. No.: US 2017/0154465 A1
(43) Pub. Date: Jun. 1, 2017

(54) SYSTEMS, APPARATUS, AND METHODS FOR PROVIDING AN AUGMENTED IMAGE OF A VIRTUAL TOMBSTONE VIA AN ELECTRONIC DEVICE

(71) Applicant: MetroStar Systems, Inc., Reston, VA (US)

(72) Inventor: Clayton Andrew Calvert, Fredericksburg, VA (US)

(73) Assignee: MetroStar Systems, Inc.

(21) Appl. No.: 14/956,194

(22) Filed: Dec. 1, 2015

(51) Int. Cl. G06T 19/00; G06T 17/05; G06F 17/30

(52) U.S. Cl. CPC G06T 19/006; G06F 17/30893; G06F 17/30867; G06T 17/05

(57) ABSTRACT

A system includes a processor, a memory, and a virtual tombstone object store configured to store one or more virtual tombstone objects, each virtual tombstone object including coordinate information and information related to a deceased individual. The system also includes a display component, and a camera component, configured to obtain a first image of a second geographical location. The system also includes a virtual tombstone management component configured to receive first coordinates defining a first geographical location and identification information identifying a specified deceased individual, create a virtual tombstone object based on the first coordinates and the identification information, store the virtual tombstone object in the virtual tombstone object store, determine second coordinates associated with the second geographical location, determine that the second coordinates match the first coordinates, generate an augmented image comprising the first image and a second image of a virtual tombstone associated with the specified deceased individual, and display the augmented image via the display component.

### TECHNICAL FIELD

This specification relates generally to systems, apparatus, and methods for providing virtual tombstone services via electronic devices, and more particularly to systems, apparatus, and methods for providing an augmented image including a virtual tombstone via an electronic device.

### BACKGROUND

The cremation rate in the United States has been increasing steadily, with the national average rate rising from approximately 3% in 1960 to approximately 40% in 2010. The rate is forecast to rise to a rate of approximately 55% by 2025. Cremation rates are rising in part because burials are becoming more expensive and cemeteries are filling up.

However, many people whose loved ones have been cremated still want a place to visit. It is possible to acquire a burial plot even when the deceased individual has been cremated; however, the gravesite must be maintained in perpetuity, and gravesites are susceptible to vandalism. Ashes can be maintained at a columbarium; however, a columbarium does not provide a very personal location for a visit.

Furthermore, some people wish to have their ashes scattered in a favorite spot, such as a favorite park, on a beach, in the ocean, etc. In most or all such cases, no permanent grave or other marker can be placed at the site where the ashes are scattered.

### SUMMARY

In accordance with an embodiment, a system provides virtual tombstone services. The system includes a processor, a memory communicatively coupled to the processor, and a virtual tombstone object store, communicatively coupled to the processor, configured to store one or more virtual tombstone objects, each virtual tombstone object including coordinate information and information related to a deceased individual. The system also includes a display component, communicatively coupled to the processor, configured to display images, a camera component, communicatively coupled to the processor, configured to obtain a first image of a second geographical location, and a virtual tombstone management component, communicatively coupled to the memory, configured to receive first coordinates defining a first geographical location and identification information identifying a specified deceased individual, create a virtual tombstone object based on the first coordinates and the identification information, store the virtual tombstone object in the virtual tombstone object store, determine second coordinates associated with the second geographical location, determine that the second coordinates match the first coordinates, generate an augmented image comprising the first image and a second image of a virtual tombstone associated with the specified deceased individual, and display the augmented image via the display component.

In one embodiment, the virtual tombstone management component is further configured to determine third coordinates of a current geographical location of the system, and determine second coordinates associated with the second geographical location based on the third coordinates.

In another embodiment, the virtual tombstone management component is further configured to determine the third coordinates of a current geographical location of the system based on GPS signals.

In another embodiment, the system further includes a compass component configured to provide directional information. The virtual tombstone component is further configured to determine a distance between the system and the second geographical location, and determine the second coordinates associated with the second geographical location based on the third coordinates, the distance, and the directional information.

In another embodiment, the second image of a virtual tombstone includes one of: an image of a tombstone, an image of a bust of the deceased individual, and an image of a statue of the deceased individual.

In another embodiment, the virtual tombstone management component is further configured to use an augmented reality technique to generate the augmented image.

In accordance with another embodiment, a system includes a processor, a memory communicatively coupled to the processor, and a virtual tombstone object store, communicatively coupled to the processor, configured to store one or more virtual tombstone objects, each virtual tombstone object comprising coordinate information and information related to a deceased individual. The system also includes a virtual tombstone management component, communicatively coupled to the memory, configured to receive first coordinates defining a first geographical location and identification information identifying a specified deceased individual, create a virtual tombstone object based on the first coordinates and the identification information, store the virtual tombstone object in the virtual tombstone object store, determine second coordinates associated with a second geographical location associated with a user device, determine that the second coordinates match the first coordinates, generate an augmented image comprising the first image and a second image of a virtual tombstone associated with the deceased individual, and cause the user device to display the augmented image.

In one embodiment, the virtual tombstone management component is further configured to determine third coordinates of a current geographical location of the device, and determine the second coordinates based on the third coordinates.

In another embodiment, the virtual tombstone management component is further configured to receive directional information from the user device, obtain distance information defining a distance between the user device and the second geographical location, and determine the second coordinates associated with the second geographical location based on the third coordinates, the distance information, and the directional information.

In another embodiment, the virtual tombstone management component is further configured to store the augmented image, generate a web page that includes the augmented image, and provide, to a second user device, access to the web page.

In another embodiment, the virtual tombstone management component is further configured to provide virtual tombstone services via the web page.

In accordance with another embodiment, a device is provided that provides a virtual tombstone service. The device includes a memory adapted to store first coordinates defining a first geographical location and information related to a deceased individual, a display device adapted to display images, and a camera adapted to obtain a first image of a second geographical location. The device also includes at least one processor adapted to determine second coordinates associated with the second geographical location, determine that the second coordinates match the first coordinates, generate an augmented image comprising the first image and a second image of a virtual tombstone associated with the deceased individual, and display the augmented image on the display device.

In one embodiment, the at least one processor is further adapted to determine third coordinates of a current geographical location of the device, and determine second coordinates associated with the second geographical location based on the third coordinates.

In another embodiment, the at least one processor is further adapted to determine the third coordinates of a current geographical location of the device based on GPS signals.

In another embodiment, the device includes a compass adapted to provide directional information. The at least one processor is further adapted to determine a distance between the device and the second geographical location, and determine the second coordinates associated with the second geographical location based on the third coordinates, the distance, and the directional information.

In another embodiment, the virtual tombstone comprises one of: an image of a tombstone, an image of a bust of the deceased individual, and an image of a statue of the deceased individual.

In another embodiment, the at least one processor is further adapted to use an augmented reality technique to generate the augmented image.

In accordance with another embodiment, a method is provided. Information associated with a deceased individual and coordinates defining a geographical location are stored by a device. A first image of the geographical location is obtained by a camera of the device. An augmented image is generated by adding a second image of a virtual tombstone associated with the deceased individual to the first image. The augmented image is displayed on a display device of the device.

In one embodiment, second coordinates associated with a current geographical location of the device are determined. Third coordinates of the geographical location are determined based on the second coordinates. A determination is made that the third coordinates match the coordinates.

In another embodiment, the second coordinates are determined based on GPS signals.

In another embodiment, the virtual tombstone includes one of: an image of a tombstone, an image of a bust of the deceased individual, and an image of a statue of the deceased individual.

In another embodiment, an augmented reality technique is used to generate the augmented image.

In accordance with another embodiment, a method is provided. A virtual tombstone associated with a deceased individual is stored in a memory, the virtual tombstone including information related to the deceased individual. A request to view a virtual tombstone associated with the deceased individual is received from a user, via a network. Access to the virtual tombstone is provided to the use, in response to the request.

In another embodiment, the virtual tombstone includes an augmented image comprising a photograph of a location where the deceased individual's ashes were scattered and an image of a virtual tombstone.

In another embodiment, access to a website that includes a first page showing the augmented image and a second page showing one of an epitaph, a poem, an obituary, a photograph of the deceased individual, and a video of the deceased individual is provided to a user.

In another embodiment, a virtual flower service allowing the user to add a virtual bouquet of flowers to the augmented image is provided on the website.

In accordance with another embodiment, a system for providing a virtual tombstone service is provided. The system includes a processor and a memory communicatively coupled to the processor. The system also includes a virtual tombstone object store, communicatively coupled to the processor, configured to store a plurality of virtual tombstone objects, a virtual tombstone object comprising data relating to a deceased an individual, the data including at least an identifier of the deceased individual and coordinates data associated with the deceased individual. The system also includes a virtual tombstone manager component communicatively coupled to the virtual tombstone object store, the virtual tombstone manager component configured to receive information related to a deceased individual, generate an augmented image comprising a virtual tombstone, and causing the augmented image to be displayed on a user device.

Other embodiments of these aspects include corresponding systems, apparatus, and computer-readable medium storing software comprising instructions executable by one or more computers, which cause the computers to perform the actions of the methods.

Further embodiments, features, and advantages, as well as the structure and operation of the various embodiments are described in detail below with reference to accompanying drawings.

### BRIEF DESCRIPTION OF THE FIGURES

Embodiments are described with reference to the accompanying drawings. In the drawings, like reference numbers may indicate identical or functionally similar elements.

FIG. 1 shows a user device in accordance with an embodiment;

FIG. 2 is a flowchart of a method of generating and displaying a virtual tombstone in accordance with an embodiment;

FIG. 3A shows a page displayed on a user device in accordance with an embodiment;

FIG. 3B shows virtual tombstone database in accordance with an embodiment;

FIG. 4A shows an image of a site captured by a camera of a user device in accordance with an embodiment;

FIG. 4B shows an augmented image in accordance with an embodiment;

FIG. 5 shows a communication system in accordance with an embodiment;

FIG. 6 shows components of virtual tombstone manager in accordance with an embodiment;

FIGS. 7A-7F show pages displayed on a user device in accordance with an embodiment;

FIG. 8 shows a page of a website associated with a deceased individual in accordance with an embodiment;

FIG. 9A shows a videos page of a website associated with a deceased individual in accordance with an embodiment;

FIG. 9B shows an obituary page of a website associated with a deceased individual in accordance with an embodiment;

FIG. 10 shows a guest book page of a website associated with a deceased individual in accordance with an embodiment;

FIG. 11 shows an augmented image that includes a virtual tombstone and virtual flowers in accordance with an embodiment;

FIG. 12 is a flowchart of a method of providing virtual tombstone services in accordance with an embodiment;

FIG. 13 is a high-level block diagram of an exemplary computer that may be used to implement certain embodiments; and

FIG. 14 shows a system in accordance with another embodiment.

### DETAILED DESCRIPTION

In accordance with an embodiment, a device generates and displays a virtual tombstone. The device stores information identifying a deceased individual and coordinates defining a geographical location where the deceased individual's ashes were scattered. A user of the device visits the location where the deceased individual's ashes were scattered, and employs a camera on the device to obtain a first image of the location. A reality augmentation technique is used to add a second image of a virtual tombstone associated with the deceased individual to the first image. Consequently, the user is able to view an augmented image showing the site where the deceased individual's ashes were scattered and a virtual tombstone placed at the site.

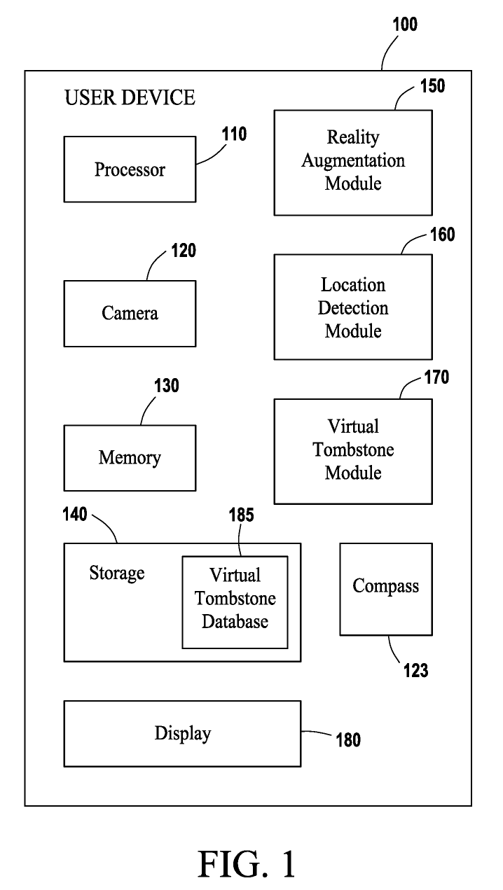

FIG. 1 shows a user device in accordance with an embodiment. User device 100 includes a processor 110, a camera 120, a compass 123, a memory 130, a storage 140, a reality augmentation module 150, a location detection module 160, a virtual tombstone module 170, and a display 180. User device 100 may be a cell phone, a laptop device, a personal computer, a smart watch, or another type of processing other device.

Processor 110 performs a variety of functions and controls the operation of other components of user device 100. Camera 120 is adapted to capture images, including photographs and video. Camera 120 may be any camera commonly available for electronic devices, for example. Compass 123 provides directional information. Memory 130 stores various types of data. Storage 140 is also adapted to store data.

Reality augmentation module 150 from time to time uses known reality augmentation techniques to augment a photograph or video. For example, reality augmentation module 150 may obtain a photograph or a video and add an image of a selected object onto the photograph or video. In one embodiment, camera 120 captures a video of a scene or event, and reality augmentation module 150 superimposes an image of a desired object onto the video in real time to generate an augmented video, and causes display 180 to display the augmented video. In another embodiment, reality augmentation module 150 modifies an image, or a frame of a video, to add an object into the image or video.

Location detection module 160 is adapted to determine a current location of user device 100. For example, location detection module 160 may include a GPS receiver and suitable processing functionality to determine a current location. Location detection module 160 also includes mapping and direction functionality.

Virtual tombstone module 170 generates a virtual tombstone at a selected location. Virtual tombstone module 170 stores first information identifying a deceased individual and second information indicating a location associated with the deceased individual (e.g., a place where the deceased individual's ashes were scattered). For example, virtual tombstone module 170 may store such information in a virtual tombstone database 185 in storage 140.

Display 180 is a display device adapted to display images. Display 180 may be a screen of a laptop device or cell phone, for example.

In one embodiment, user device 100 is a cell phone. One or more of the components of user device 100 shown in FIG. 1 may be implemented, for example, by a cell phone app. Alternatively, components of user device 100 may be implemented by a combination of software and circuitry.

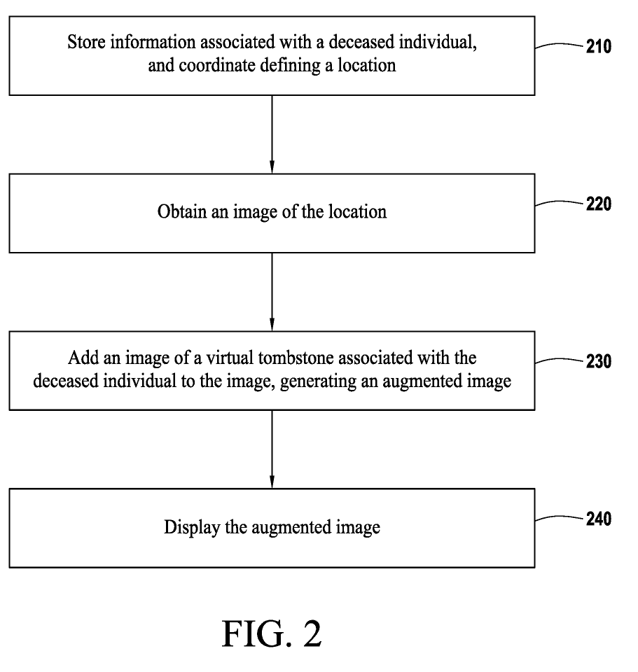

In accordance with an embodiment, a user may employ user device 100 to generate and view a virtual tombstone. FIG. 2 is a flowchart of a method of generating and displaying a virtual tombstone in accordance with an embodiment.

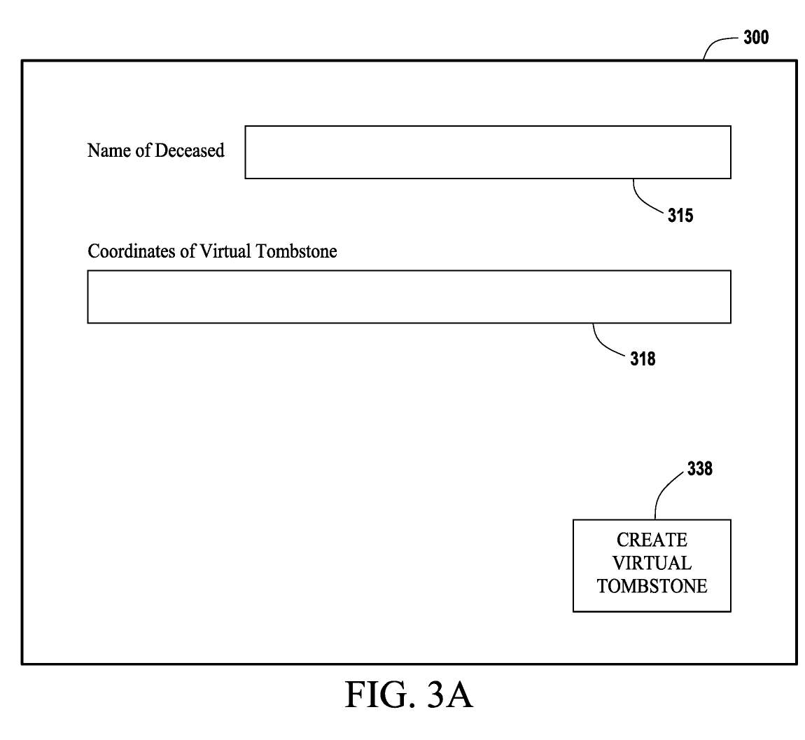

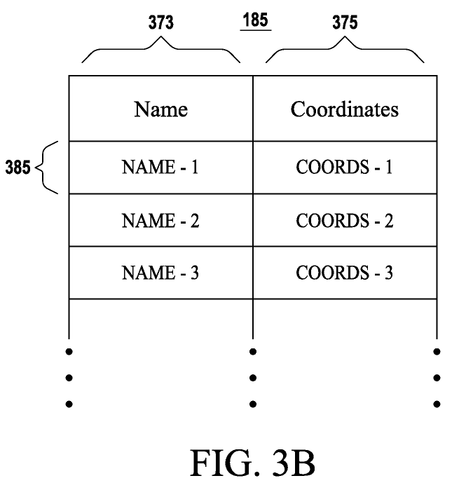

At step 210, information associated with a deceased individual, and coordinates defining a location, are stored. In an illustrative embodiment, suppose that a user wishes to create a virtual tombstone for his deceased father, Robert Smith. Virtual tombstone module 170 causes user device 100 to display a page such as that shown in FIG. 3A. Page 300 includes a field 315 in which the user may enter the name of the deceased individual. Accordingly, the user may enter the name “Robert Smith.” Page 3A also includes a field 318 in which the user specifies coordinates of a location associated with the deceased individual. For example, the user may specify the coordinates of the location where the deceased individual's ashes were scattered. Coordinates may be entered in any suitable format, such as latitude/longitude data or in another format.

Suppose that Robert Smith's ashes were scattered at a particular site in a field, at a location that he had frequently visited. Accordingly, the user obtains coordinate data defining the geographical location of the spot where the ashes were scattered, and enters the coordinates in field 318.

In one embodiment, if the coordinates of the site where the deceased individual's ashes were scattered are unknown and/or unknowable, the user may select a site appropriate for use as a memorial to the deceased individual, and enter the coordinates of the selected site. For example, if the deceased individual's ashes were scattered over the ocean, the user may select a site on a beach proximate to the region of the ocean where the ashes were scattered, or may select a site at a location that the deceased individual liked to visit, and enter the coordinates of the selected site.

After the user has entered the name of the deceased individual and the coordinate data, the user selects a CREATE VIRTUAL TOMBSTONE button 338.

Virtual tombstone module 170 receives the information entered by the user and stores the information. In an illustrative embodiment, virtual tombstone module 170 stores the information in virtual tombstone database 185, which is maintained in storage 140. FIG. 3B shows virtual tombstone database 185 in accordance with an embodiment. Database 185 includes a column 373 that holds names of one or more deceased individuals. Database 185 also includes a column 375 that stores coordinates data associated with each respective deceased individual specified in column 373. The coordinates may be the coordinates of the site where the deceased individual's ashes were scattered. Thus, referring to record 385, a deceased individual with the name NAME-1 is associated with coordinate data COORDS-1.

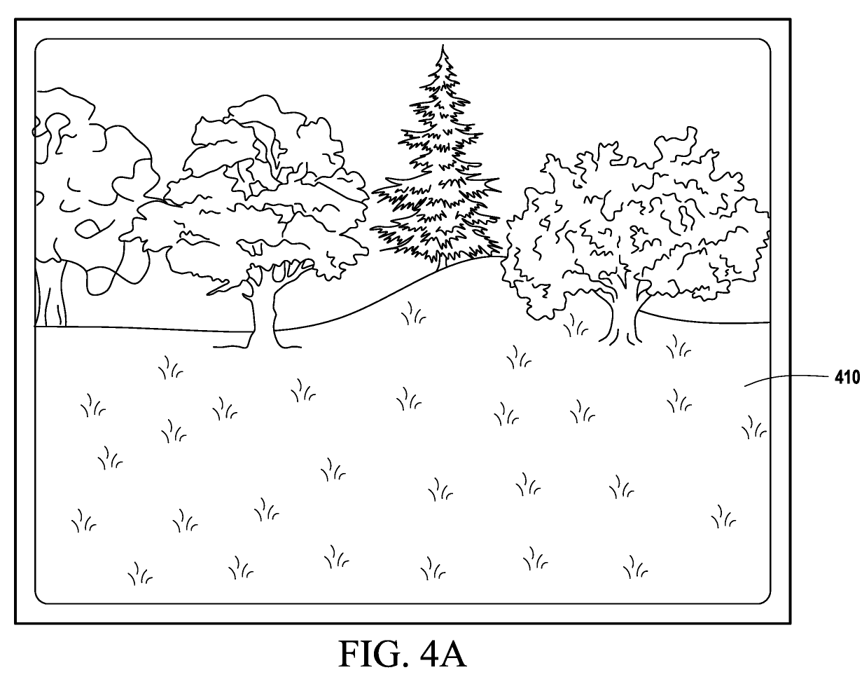

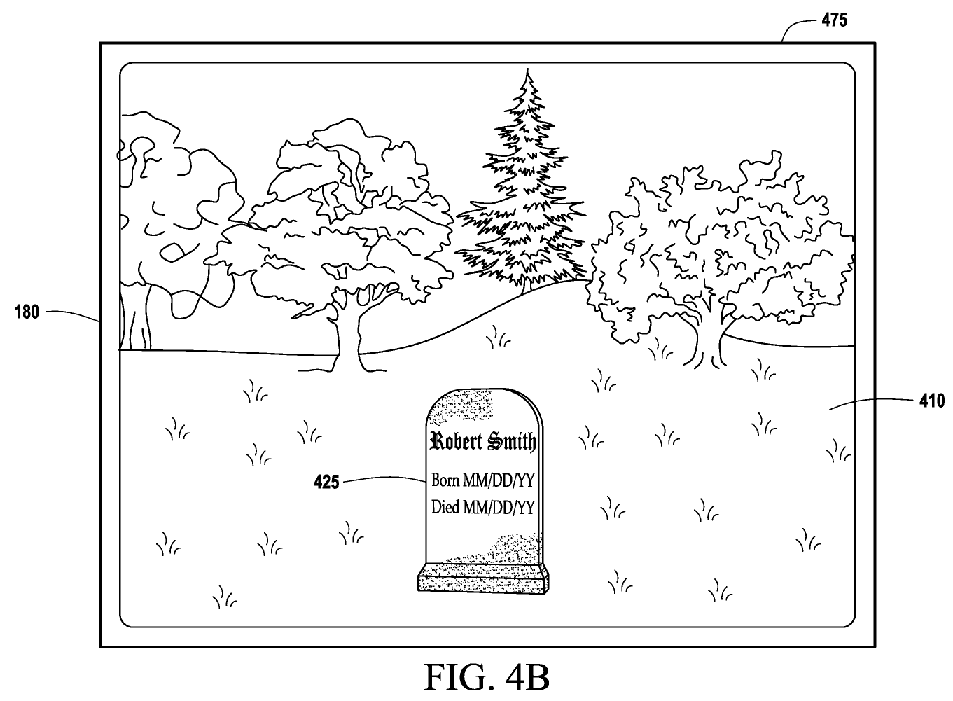

At step 220, an image of the location is obtained. Suppose now that the user now visits the spot where his father's ashes were scattered. The user stands near the site where the ashes were scattered and employs camera 120 of user device 100 to capture an image of the site. FIG. 4A shows an image 410 of the site where the ashes were scattered in accordance with an embodiment. In the illustrative embodiment, image 410 is an image of a field and trees. The image may be a still image. Alternatively, camera 120 may generate a video of the location, and image 410 may be a frame of the video.

Location detection module 160 monitors the current location of user device 100. Location detection module 160 also determines the coordinates of the site being imaged in the photo or video generated by camera 120. In one embodiment, location detection module 160 concludes that the image captured by camera 120 is an image of the desired site if user device 100 is sufficiently near the coordinates of the site. For example, location detection module 160 may use image analysis techniques to determine a distance between user device 100 and a site on the ground that is being imaged. If the site being imaged by camera 120 is less than a predetermined distance (e.g., 20 feet) from user device 100, then location detection module 160 may determine the coordinates of the site being imaged to be the same as the coordinates of the current location of user device 100. Other methods may be used to determine the coordinates of a site being imaged, and other systems and methods may be used to determine a distance between a site being imaged and user device 100 (such as optical/laser detectors, etc.).

For example, in another embodiment, location detection module 160 uses image analysis capability to determine a distance between user device 100 and a site on the ground that is being imaged, and receives compass/directional information from compass 123 to determine a direction in which the camera is pointing Location detection module 160 then determines the coordinates of the site being imaged based on (1) the current coordinates of user device 100, (2) the distance from user device 100 to the site being imaged and (3) the direction in which the camera is pointing.

Virtual tombstone module 170 accesses virtual tombstone database 185 and compares the coordinates of the site being imaged by camera 120 to the desired coordinates stored in database 370. When virtual tombstone module 170 determines that the coordinates of the site imaged by camera 120 matches the set of coordinates stored in database 185, virtual tombstone module 170 generates a virtual tombstone at the location.

In the illustrative embodiment, virtual tombstone module 170 determines that the coordinates of the site being imaged by camera 120 match the coordinates associated with the deceased individual (Robert Smith). Accordingly, at step 230, an image of a virtual tombstone associated with the deceased individual is added to the image, generating an augmented image. In the illustrative embodiment, virtual tombstone manager 170 causes reality augmentation module 150 to generate an augmented image that includes the image of the site (including field and trees) being imaged by camera 120, and a virtual tombstone of Robert Smith. Specifically, reality augmentation module 150 adds an image of a tombstone to the image captured by camera 120. FIG. 4B shows an augmented image 475 in accordance with an embodiment. Augmented image 475 includes a virtual tombstone 425 added to image 410 of FIG. 4A. Reality augmentation module 150 may generate an augmented still image or an augmented video of the site where the deceased individual's ashes were scattered.

At step 240, the augmented image is displayed. As shown in FIG. 4B, virtual tombstone module 170 causes augmented image 475 to be displayed on display 180. The user may now film, in real time, the scene of the site where the deceased individual's ashes were scattered, but view the augmented imagery that includes virtual tombstone 425.

In another embodiment, virtual tombstone module 170 generates a 3-dimensional virtual tombstone. Thus, the user can walk around the site where the deceased individual's ashes were scattered with camera 120, and view virtual tombstone 425 from all sides, as a three-dimensional object.

In another embodiment, a three-dimensional scan is completed of the deceased individual's body (while individual is still alive), and the data is stored. Subsequently, a virtual tombstone may be generated based on the scanned data. For example, a virtual tombstone may include a bust, or a full-sized statue, of the deceased individual.

In accordance with another embodiment, methods and systems described herein may be used to provide a virtual tombstone service via a network such as the Internet. For example, a virtual tombstone manager may reside and function on a server, and store information relating to a deceased individual, including the individual's name and coordinates of a geographical location where the individual's ashes were scattered. A user may employ a user device, such as a cell phone or laptop device, to access the virtual tombstone manager via the Internet. If the virtual tombstone manager determines that the user's user device is currently capturing an image of the site where the deceased individual's ashes were scattered, the virtual tombstone manager may augment the image to include a virtual tombstone and cause the user device to display the augmented image, showing the image of the site and a virtual tombstone.

Alternatively, the virtual tombstone manager may store an augmented image showing an image of the site where the individual's ashes were scattered and a virtual tombstone appearing on the ground at the site. Any user may access and view the augmented image from any location.

In one embodiment, the virtual tombstone manager provides access to a website that includes a web page containing the augmented image. A user employing a user device may access the website from any location, via a network, and view the augmented image. The website may also include other information related to the deceased individual such as photographs, videos, an epitaph, and provide other services such as a guest book, a flower delivery service, etc. An illustrative embodiment of a website that provides such services is described herein and in the Drawings; however, in other embodiments, a website may be structured differently and may provide other types of services.

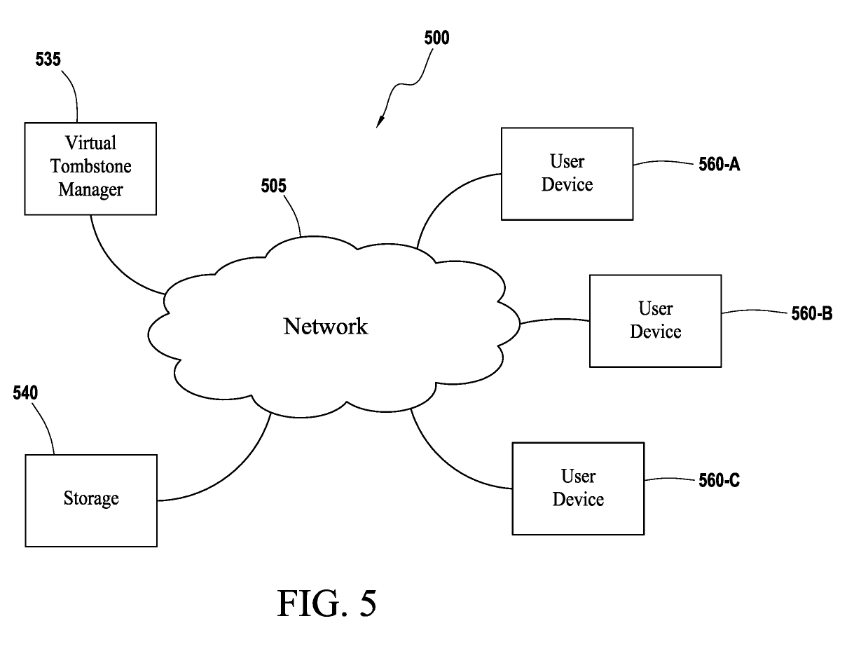

FIG. 5 shows a communication system in accordance with an embodiment. Communication system 500 includes a network 505, a virtual tombstone manager 535, a storage 540, and a plurality of user devices 560-A, 560-B, 560-C. Communication system 500 may include any number of user devices.

Network 505 may include one or more of a number of different types of networks, such as, for example, an Internet, a local area network (LAN), a wide area network (WAN), a wireless network, a Fibre Channel-based storage area network (SAN), an iSCSI-based network, etc. Other networks may be used.

Each user device 560-A, 560-B, 560-C may be a may be a cell phone, a laptop device, a personal computer, a smart watch, or another type of processing other device.

Storage 540 may include any type of storage device capable of storing data. Storage 540 may include block-level or file level storage device, for example. Storage 540 may include a network storage device.

Virtual tombstone manager 535 provides a virtual tombstone service to users via network 505. For example, virtual tombstone manager 535 may cause a selected user device to display an augmented image including a scene of a location and a virtual tombstone added to the scene.

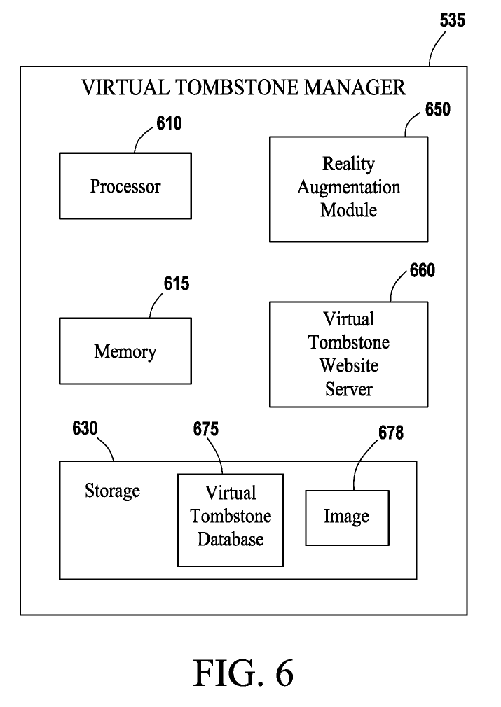

FIG. 6 shows components of virtual tombstone manager 535 in accordance with an embodiment. Virtual tombstone manager 535 includes a processor 610, a memory 615, a storage 630, a reality augmentation module 650, and a virtual tombstone website server 660. Processor 610 controls the operation of various components of virtual tombstone manager 535. Memory 615 stores data. Storage 630 also stores data. Reality augmentation module 650 uses reality augmentation techniques to add a virtual tombstone to an image. Virtual tombstone website manager 660 provides services to users via network 505.

In accordance with an embodiment, virtual tombstone manager 535 provides various virtual tombstone services to users via network 505. Suppose, for example, that a user wishes to create a virtual tombstone for her deceased mother, Jane Smith. In an illustrative embodiment, the user employs user device 560-A to access virtual tombstone manager 535. Virtual tombstone manager 535 may determine that the user is a new user and cause user device 160-A to display a page that enables the user to create a virtual tombstone for her mother.

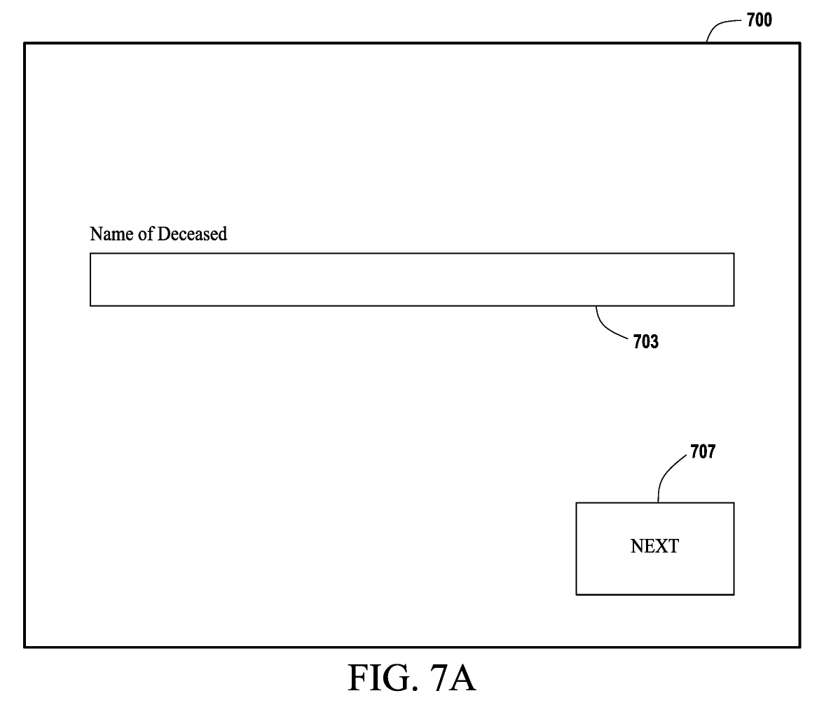

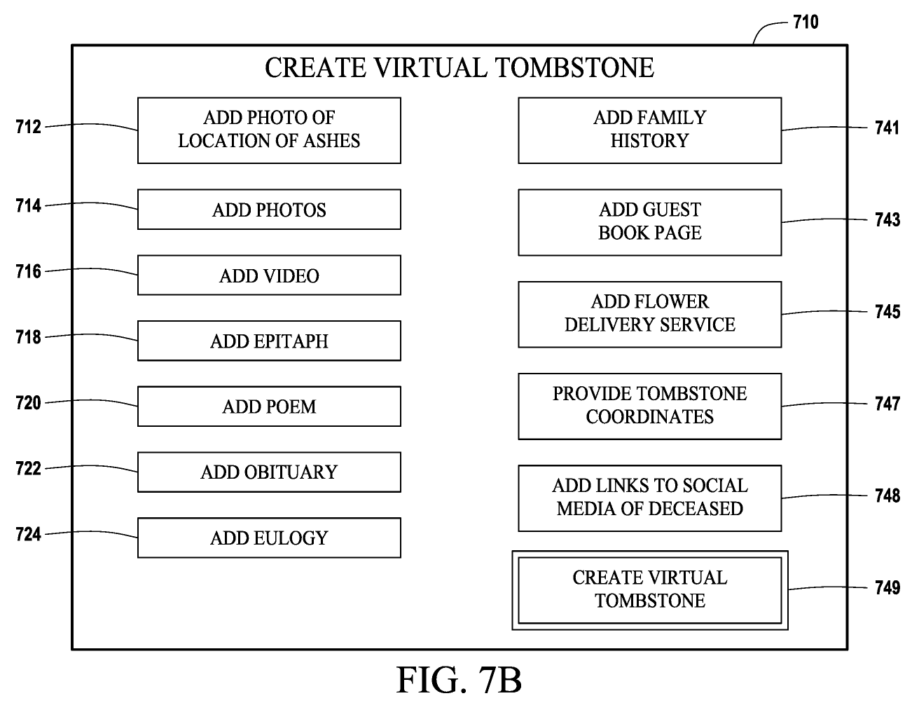

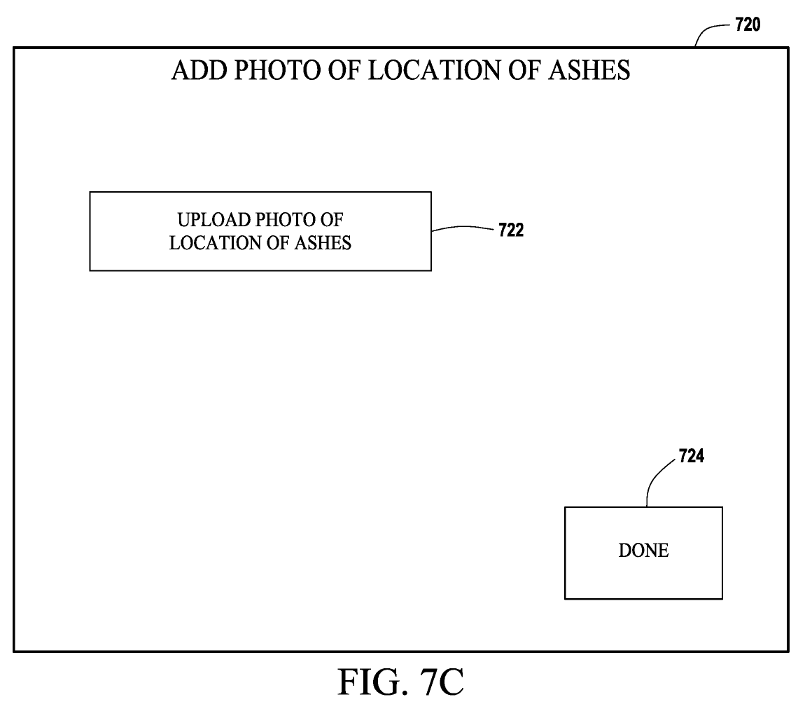

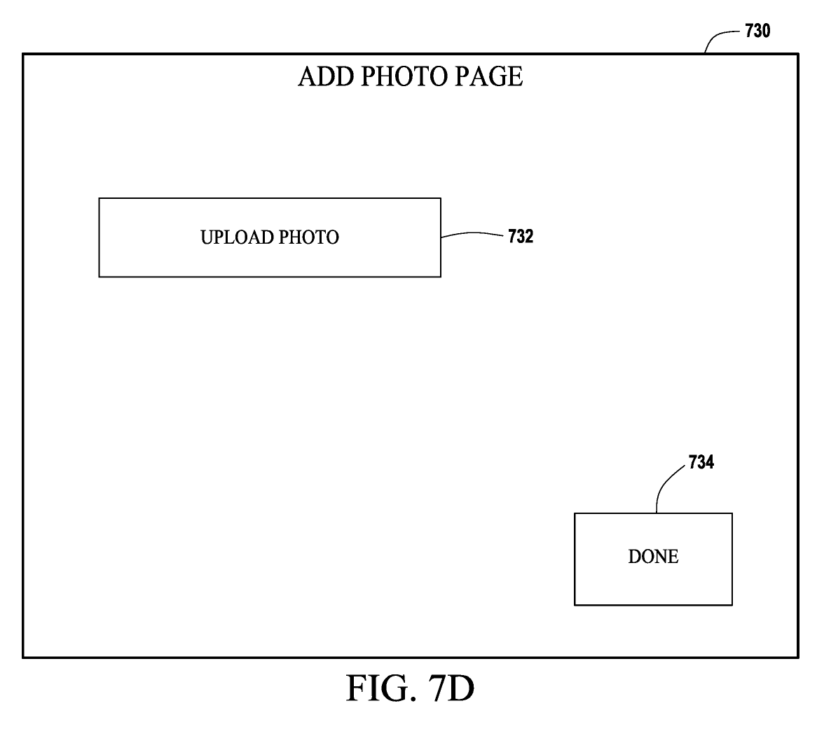

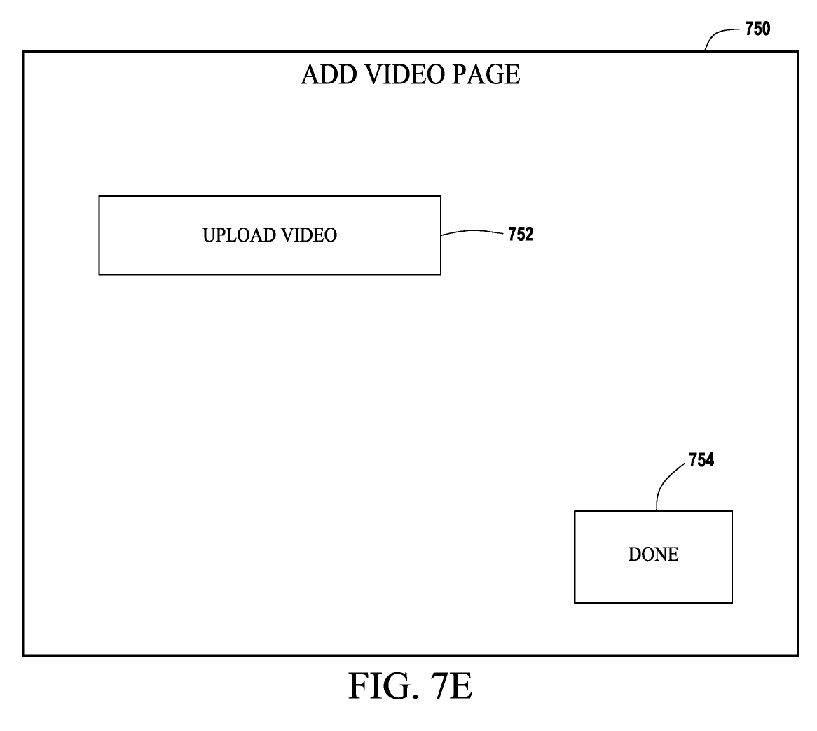

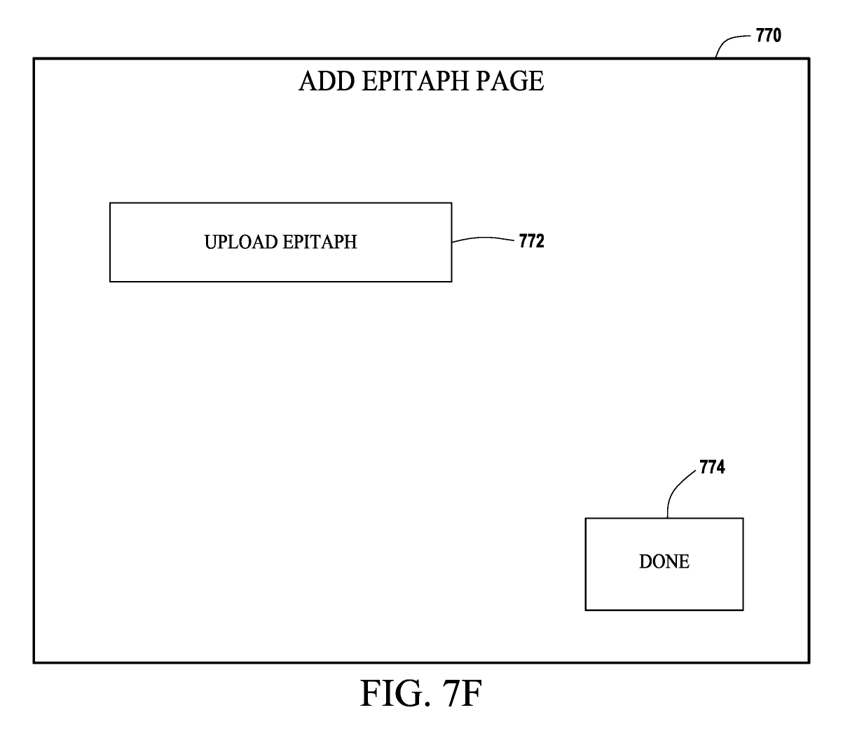

For example, virtual tombstone manager 535 may cause user device 560-A to display a page such as that shown in FIG. 7A. Page 700 includes a field 703 allowing the user to enter the name of the deceased individual. In the illustrative embodiment, the user enters the name “Jane Smith.” The user may then select a “NEXT” button 707 to submit the name information.

Virtual tombstone website server 660 receives the name information and causes user device 560-A to display a “Create Virtual Tombstone” page such as that shown in FIG. 7B. Page 710 includes a plurality of options enabling a user to add customized content to a virtual tombstone website. Thus, page 710 includes an ADD PHOTO OF LOCATION OF ASHES option 712, an ADD PHOTO option 714, an ADD VIDEO option 716, an ADD EPITAPH option 718, an ADD POEM option 720, an ADD OBITUARY option 722, an ADD EULOGY option 724, and an ADD FAMILY HISTORY option 741. Page 710 also includes an ADD GUEST BOOK PAGE option 743 and an ADD FLOWER DELIVERY SERVICE option 745. Page 710 also includes a PROVIDE TOMBSTONE COORDINATES option 747. Page 710 also includes an ADD LINKS TO SOCIAL MEDIA OF DECEASED option 748. A CREATE VIRTUAL TOMBSTONE button 749 is located at the bottom of page 710.

In the illustrative embodiment, the user selects PROVIDE TOMBSTONE COORDINATES button 747 and, in a manner similar to that described above, is prompted to enter the geographical coordinates defining the site where the deceased individual's ashes were scattered. Supposing, for example, that Jane Smith's ashes were scattered at a favorite beach, the user may provide the coordinates of the spot on the beach where the ashes were scattered. Referring to FIG. 6, virtual tombstone website server 660 may store the coordinates information in a virtual tombstone database 675, maintained in storage 630.

The user also may also select ADD PHOTO OF LOCATION OF ASHES button 712. In response, virtual tombstone website server 660 causes user device 560-A to display a page such as that shown in FIG. 7C. Page 720 includes an UPLOAD PHOTO OF LOCATION OF ASHES button 722. In a well-known manner, the user may upload a photograph of the site where the deceased individual's ashes (i.e., Jane Smith's) ashes were scattered. The user then selects a DONE button 724. Referring to FIG. 6, virtual tombstone website server 660 stores the photograph as image 678 in storage 630.

The user now selects ADD PHOTOS button 714. In response, virtual tombstone website server 660 causes user device 560-A to display a page such as that shown in FIG. 7D. Page 730 includes an UPLOAD PHOTO button 732. In a well-known manner, the user uploads a photograph, such as a photograph of the deceased individual, a photo of an event in the deceased individual's life, etc. Multiple photographs may be uploaded. The user then selects a DONE button 734. Virtual tombstone website server 660 receives and stores the photograph(s).

The user now selects ADD VIDEO button 716. In response, virtual tombstone website server 660 causes user device 560-A to display a page such as that shown in FIG. 7E. Page 750 includes an UPLOAD VIDEO button 752. In a well-known manner, the user uploads a video, such as a video of the deceased individual. For example, the video may be a video made by the deceased individual before he or she died. Multiple videos may be uploaded. The user then selects a DONE button 754. Virtual tombstone website server 660 receives and stores the video(s).

The user now selects ADD EPITAPH button 718. In response, virtual tombstone website server 660 causes user device 560-A to display a page such as that shown in FIG. 7F. Page 770 includes an UPLOAD EPITAPH button 772. The user may upload an epitaph associated with the deceased individual. The user then selects a DONE button 774. Virtual tombstone website server 660 receives and stores the epitaph.

In a similar manner, virtual tombstone website server 660 may allow the user to upload an obituary, a eulogy, and family history information. Referring again to FIG. 7B, if the user wishes to include a guest book on the website, the user may select button 743.

If the user wishes to add a link to a social media page (e.g., a Facebook page) of the deceased individual, the user may select ADD LINKS TO SOCIAL MEDIA OF DECEASED option 748. The user may specify a link to one or more selected social media pages.

Virtual tombstone website server 660 stores the data entered by the user , including the photographs, videos, poems, epitaphs, obituaries, family history information, guest book information, links, etc. Virtual tombstone website server 660 also stores the coordinate data defining the location where the deceased individual's ashes were scattered. For example, the data may be stored in virtual tombstone database 675 in storage 630, shown in FIG. 6. Alternatively, the user's data may be stored remotely in storage 540 (shown in FIG. 5).

In accordance with an embodiment, virtual tombstone website server 660 builds and maintains a website associated with the deceased individual, based on the information provided by the user. Subsequently, any person may employ a user device to access the website associated with the deceased individual. While accessing the website, the user may view an augmented image of the site where the deceased individual's ashes were scattered (augmented with an image of a virtual tombstone). The user may also view the photos, videos, epitaphs, obituary, poem, family history, etc., that were added to the website.

For example, suppose that a second user visits the spot on the beach where Jane Smith's ashes were scattered. Suppose further that the second user employs user device 535-B to access virtual tombstone manager 535 and, in particular, accesses the website associated with Jane Smith. The second user further employs a camera component of user device 560-B to capture a video of the spot on the beach where the ashes were scattered. In a manner similar to that described above, virtual tombstone manager 535 causes user device 535-B to display an augmented image (or an augmented video) of the site with a virtual tombstone added to the video or image.

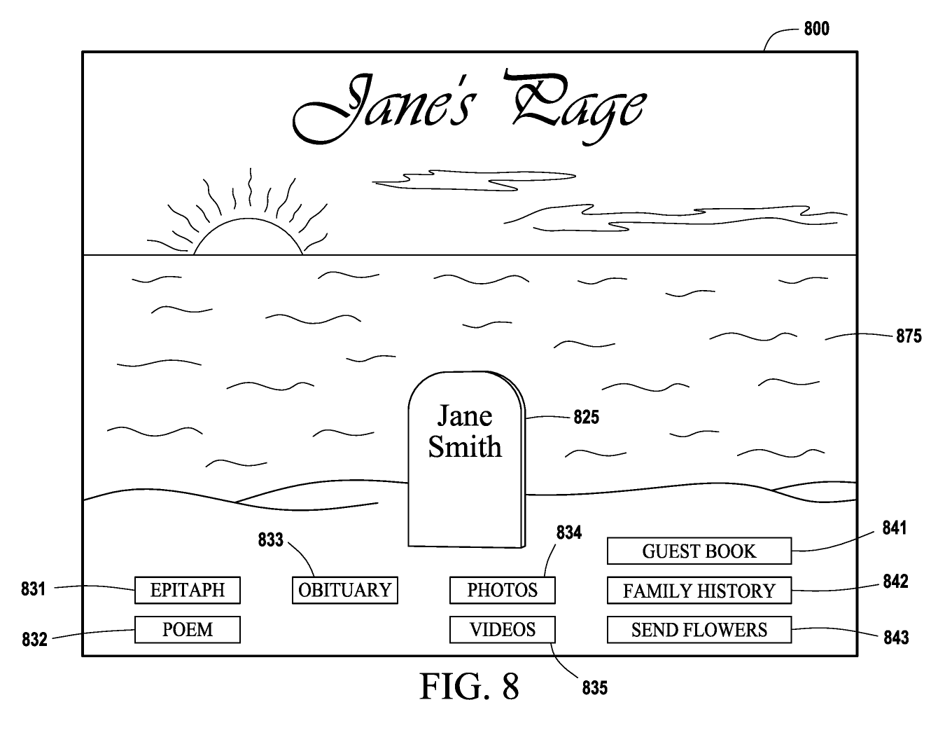

In another embodiment, virtual tombstone manager 535 allows the website, and an augmented image including a virtual tombstone, to be accessed by any user at any location. Suppose, for example, that a third user, while sitting at home, employs user device 560-C to access a website associated with Jane Smith. Virtual tombstone website server 660 may retrieve image 678 (the image of the beach where Jane Smith's ashes were scattered) from storage 630 and cause user device 560-C to display the image augmented by a virtual tombstone. Thus, in an illustrative embodiment, virtual tombstone website server 660 causes user device 560-C to display a page associated with Jane Smith, such as that shown in FIG. 8. Page 800 includes an augmented image 875 that includes a photograph of the beach where Jane Smith's ashes were scattered, augmented by a virtual tombstone 825.

In the illustrative embodiment, page 800 also serves as a home page of a website associated with Jane Smith. Thus, page 800 also includes buttons 831, 832, 833, 834, 835, providing options to view an epitaph, a poem, an obituary, photos, and videos, respectively. Page 800 also includes buttons 841 and 842 allowing the user to access a guest book and family history information. In other embodiments, page 800 may include other options. For example, page 800 may include a link to a social media page (e.g., a Facebook page) associated with Jane Smith.

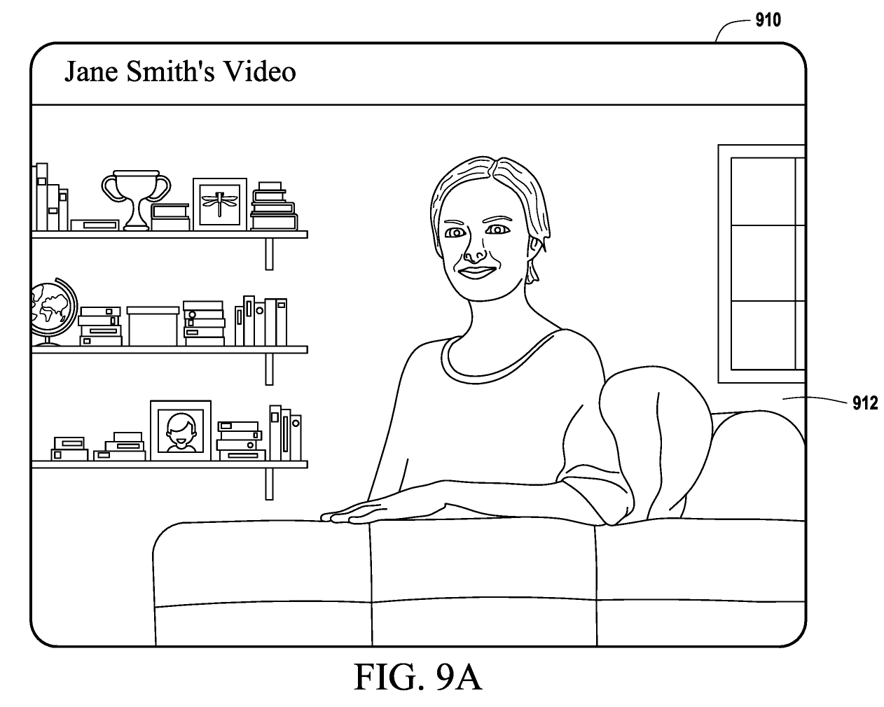

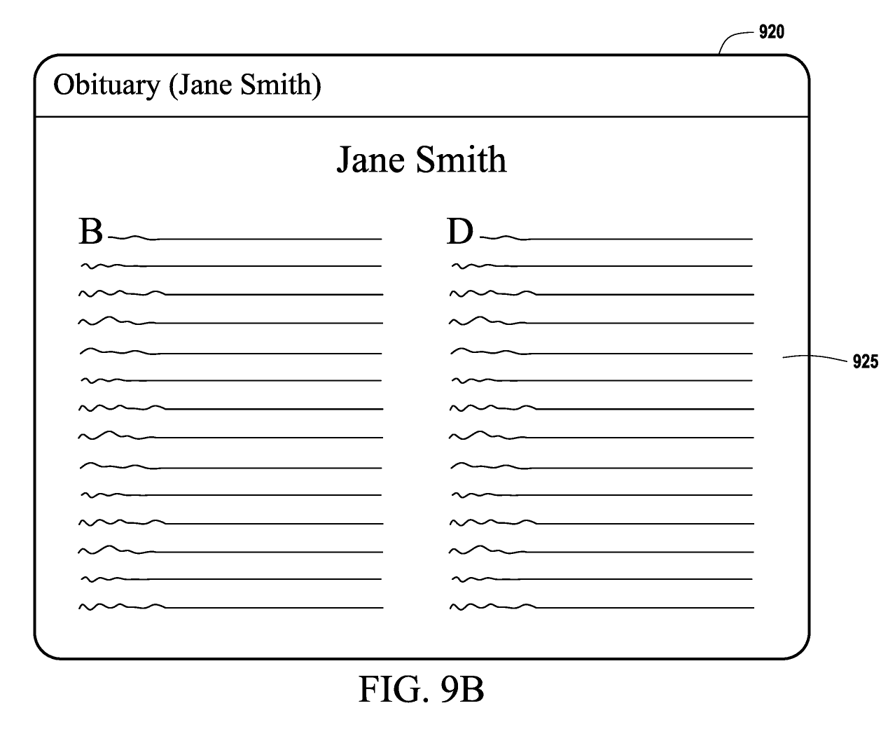

Supposing that the user selects VIDEOS button 835, virtual tombstone website server 660 causes user device 560-C to display a page such as that shown in FIG. 9A. Page 910 includes a video 912 of Jane Smith.

Referring again to FIG. 8, if the user selects OBITUARY button 833, virtual tombstone website server 660 causes user device 560-C to display a page such as that shown in FIG. 9B. Page 920 includes an obituary 925 of Jane Smith.

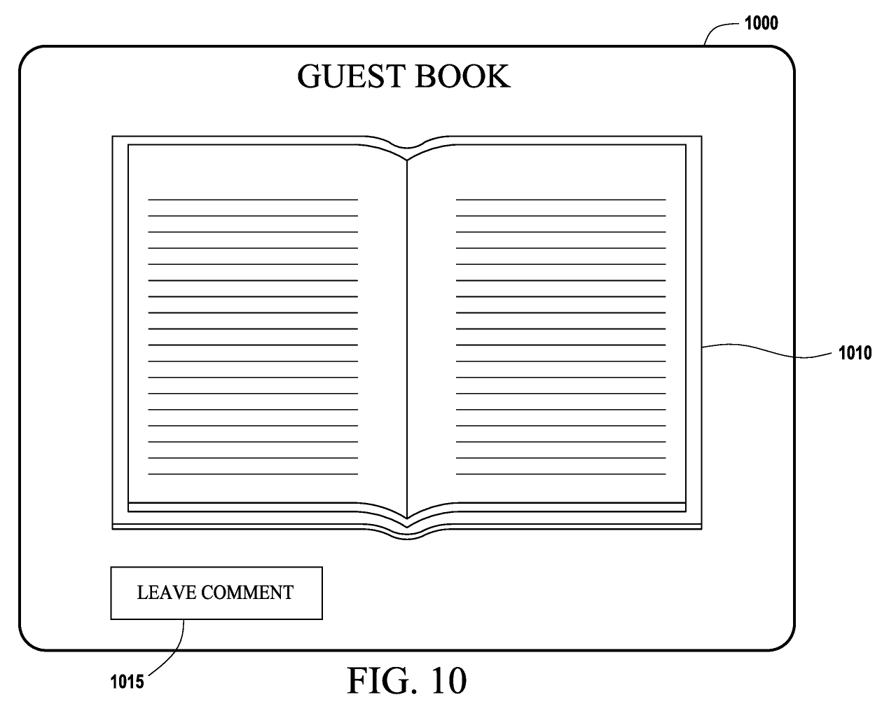

Referring again to FIG. 8, if the user selects GUEST BOOK button 841, virtual tombstone website server 660 causes user device 560-C to display a page such as that shown in FIG. 10. Guest book page 1000 includes a view of a guest book 1010, which includes comments left by visitors to the website. The user may select a “Leave Comment” button 1015 to leave a comment in the Guest Book. Selection of the “Leave Comment” button causes a field/prompt to appear that allows the user to enter a comment. The user's comment is then added to the comments on the guest book.

In another embodiment, a guest book page may be linked to one or more social media websites such as Facebook, Twitter, etc. For example, a user may post an image of the guest book, and a link to the guest book page, on the user's Facebook page, or in a tweet posted on Twitter. Similarly, a link to the home page of the virtual tombstone website (e.g., the “Jane's Page” 800 shown in FIG. 8) may be posted on a page on a social media website. In one embodiment, a link to a social media page (e.g., a Facebook page) of the deceased individual may be added to the guestbook page.

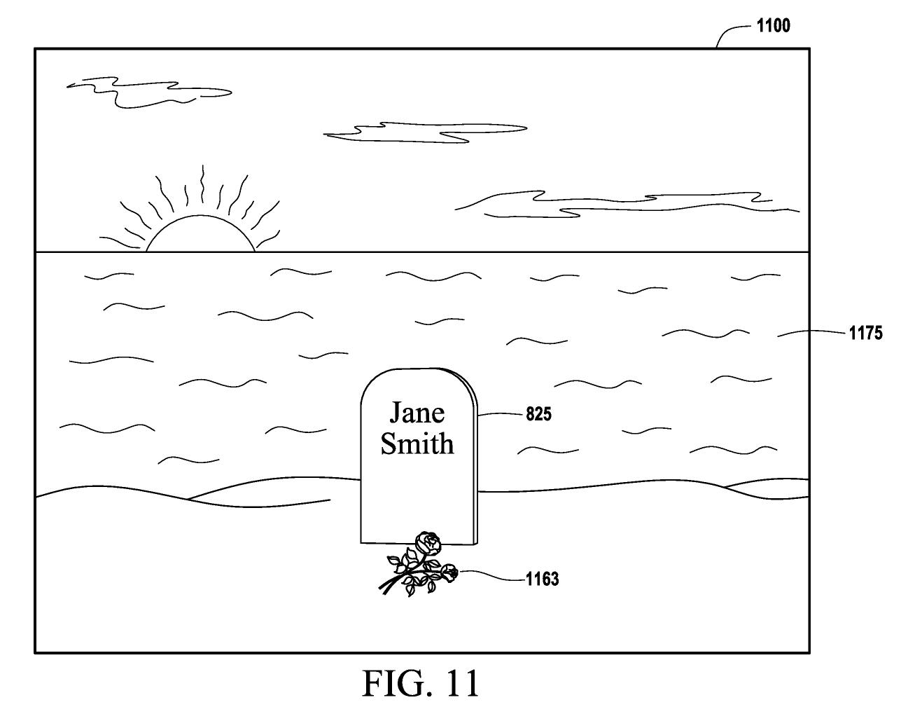

Referring again to FIG. 8, if the user selects SEND FLOWERS button 843, virtual tombstone website server 660 causes user device 560-C to display a page such as that shown in FIG. 11. Page 1100 includes an augmented image of the beach where Jane Smith's ashes were scattered. Virtual tombstone 825 has been added to the image. In addition, a virtual bouquet of flowers 1163 has been added to the image.

In another embodiment, when a user selects SEND FLOWERS button 843, virtual tombstone website server 660 provides the user an opportunity to have real flowers delivered to a physical location. For example, virtual tombstone website server 660 may prompt the user to specify a type of flowers to be delivered, and then inform the user that flowers will be delivered to a predetermined columbarium. Virtual tombstone website server 660 may then contact a flower delivery service and place an order for flowers to be delivered to the columbarium based on the information provided by the user. In another embodiment, virtual tombstone website server 660 may prompt the user to specify an address or location, and to specify a type of flowers to be delivered. Virtual tombstone website server 660 may then contact a flower delivery service and place an order for flower delivery based on the information provided by the user.

In another embodiment, a virtual tombstone website may include an option that allows a user to make a donation to a charity selected by the deceased individual, or a charity selected in honor of the deceased individual. This function may prompt the user to enter a credit card number and an amount to be donated, for example. Alternatively, the virtual tombstone website may include a link to the charity's website.

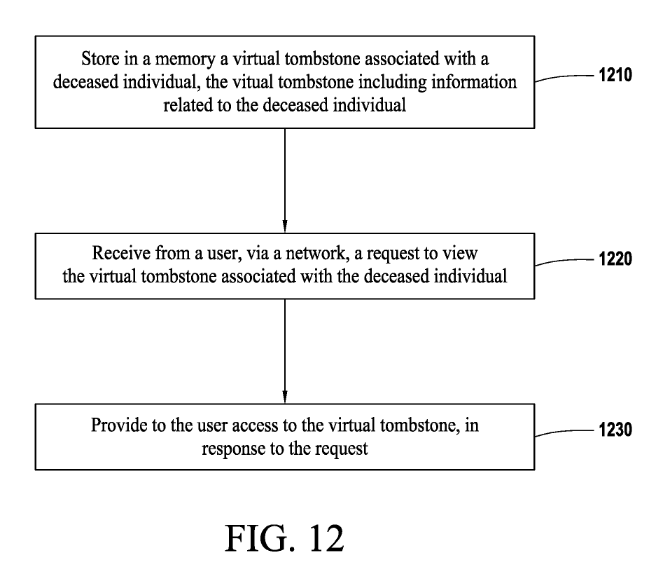

FIG. 12 is a flowchart of a method of providing virtual tombstone services in accordance with an embodiment. At step 1210, a virtual tombstone associated with a deceased individual is stored in a memory, the virtual tombstone including information related to the deceased individual. At step 1220, a request to view the virtual tombstone associated with the deceased individual is received from a user, via a network. At step 1230, access to the virtual tombstone is provided to the user, in response to the request.

In another embodiment, data relating deceased individuals and data related to virtual tombstones may be stored in the form of objects. Object-oriented programming in known. Thus, in one embodiment, a system for providing a virtual tombstone service is provided. The system includes a processor, and a memory communicatively coupled to the processor. The system also includes a virtual tombstone object store, communicatively coupled to the processor, configured to store a plurality of virtual tombstone objects, a virtual tombstone object comprising data relating to a deceased an individual, the data including at least an identifier of the deceased individual and coordinates data associated with the deceased individual. The system further includes a virtual tombstone manager component communicatively coupled to the virtual tombstone object store, the virtual tombstone manager component configured to receive information related to a deceased individual, generate an augmented image comprising a virtual tombstone, and causing the augmented image to be displayed on a user device.

In various embodiments, the method steps described herein, including the method steps described in FIG. 2 AND/OR FIG. 12, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 2 AND/OR FIG. 12, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Device 100 and/or system 500 may be software, firmware, or hardware or any combination thereof in a computing device. A computing device can be any type of computing device having one or more processors. For example, a computing device can be a computer, server, workstation, mobile device (e.g., a mobile phone, personal digital assistant, navigation device, tablet, laptop, or any other user carried device), game console, set-top box, kiosk, embedded system or other device having at least one processor and memory. A computing device may include a communication port or I/O device for communicating over wired or wireless communication link(s).

Computing devices such as a monitor, all-in-one computer, smart phone, tablet computer, remote control, etc., may include a touch screen display that accepts user input via touching operations performed by a user's fingers or other instrument. For example purposes, a touch sensor grid may overlay the display area. The touch sensor grid contains many touch sensitive areas or cells that may be used to locate the area closest to the input of a user's touch.

Example touch operations using a touch screen display may include (but are not limited to) pinching, finger (or other stylus or object) touches, finger releases, and finger slides. Finger slides may be circular or any other shape, direction or pattern. The touch screen display may include a screen or monitor that may render text and/or images.

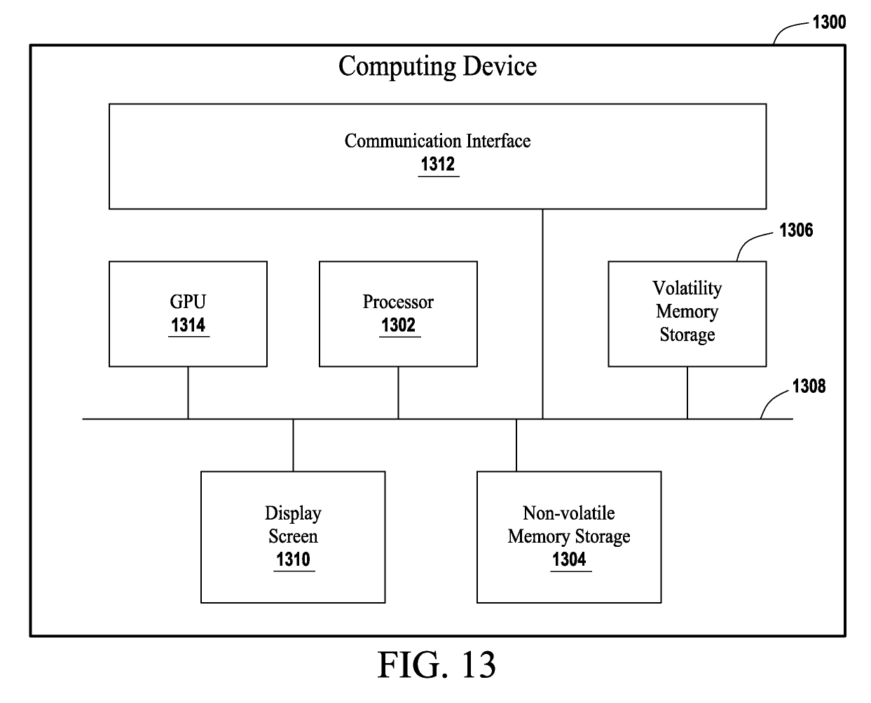

FIG. 13 is an example computer system 1300 in which embodiments of the present invention, or portions thereof, may be implemented as computer-readable code. For example, the components of device 100 and/or system 100 may be implemented in one or more computer systems 1300 using hardware, software implemented with hardware, firmware, tangible computer-readable media having instructions stored thereon, or a combination thereof and may be implemented in one or more computer systems or other processing systems. Components in the Drawings may be embodied in any combination of hardware and software.

Computing devices, such as device 100 and/or components of system 500, may include one or more processors 1302, one or more non-volatile storage mediums 1304, one or more memory devices 1306, a communication infrastructure 1308, a display screen 1310 and a communication interface 1312.

Processors 1302 may include any conventional or special purpose processor, including, but not limited to, digital signal processor (DSP), field programmable gate array (FPGA), application specific integrated circuit (ASIC), and multi-core processors.

GPU 1314 is a specialized processor that executes instructions and programs, selected for complex graphics and mathematical operations, in parallel.

Non-volatile storage 1304 may include one or more of a hard disk drive, flash memory, and like devices that may store computer program instructions and data on computer-readable media. One or more of non-volatile storage device 1304 may be a removable storage device.

Memory devices 1306 may include one or more volatile memory devices such as but not limited to, random access memory. Communication infrastructure 1308 may include one or more device interconnection buses such as Ethernet, Peripheral Component Interconnect (PCI), and the like.

Typically, computer instructions are executed using one or more processors 1302 and can be stored in non-volatile storage medium 1304 or memory devices 1306.

Display screen 1310 allows results of the computer operations to be displayed to a user or an application developer.

Communication interface 1312 allows software and data to be transferred between computer system 1300 and external devices. Communication interface 1312 may include a modem, a network interface (such as an Ethernet card), a communications port, a PCMCIA slot and card, or the like. Software and data transferred via communication interface 1312 may be in the form of signals, which may be electronic, electromagnetic, optical, or other signals capable of being received by communication interface 1312. These signals may be provided to communication interface 1312 via a communications path. The communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device, causes a data processing device(s) to operate as described herein.

Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

Embodiments of the invention and all of the functional operations described in this specification may be implemented in digital electronic circuitry, or in computer software, firmware, or hardware, including the structures disclosed in this specification and their structural equivalents, or in combinations of one or more of them. Embodiments of the invention may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

One skilled in the art will recognize that an implementation of an actual computer or computer system may have other structures and may contain other components as well, and that FIG. 13 is a high level representation of some of the components of such a computer for illustrative purposes.

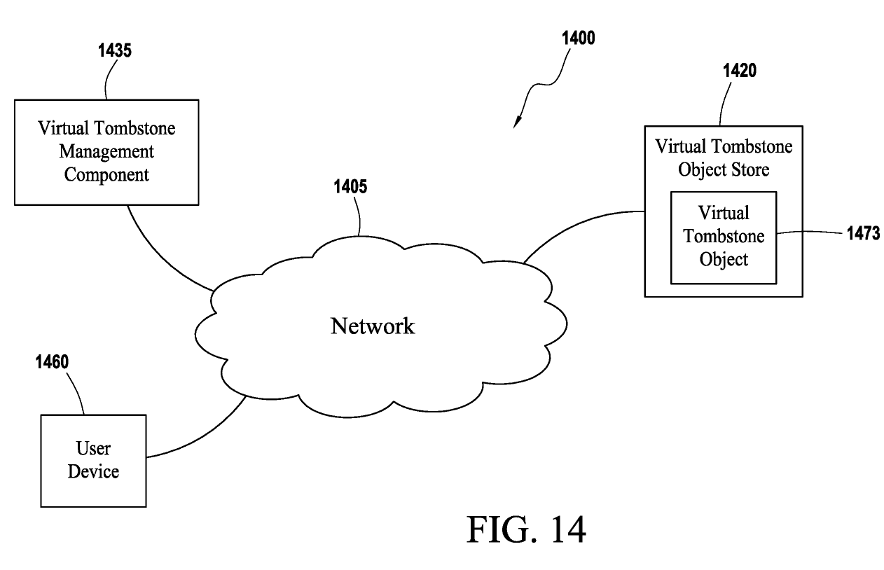

FIG. 14 shows a system in accordance with another embodiment. System 1400 includes a network 1405, a virtual tombstone management component 1435, a virtual tombstone object store 1420, and a user device 1460. Virtual tombstone management component 1435 may perform some or all of the functions of virtual tombstone manager 535. Virtual tombstone object store 1420 stores one or more virtual tombstone objects, such as virtual tombstone object 1473.

Thus, in one embodiment, virtual tombstone object store 1420 may store one or more virtual tombstone objects, each virtual tombstone object comprising coordinate information and information related to a deceased individual. Virtual tombstone management component 1435 may receive first coordinates defining a first geographical location and identification information identifying a specified deceased individual, create a virtual tombstone object based on the first coordinates and the identification information, store the virtual tombstone object in the virtual tombstone object store, determine second coordinates associated with a second geographical location associated with a user device, determine that the second coordinates match the first coordinates, generate an augmented image comprising the first image and a second image of a virtual tombstone associated with the deceased individual, and cause the user device to display the augmented image.

In accordance with another embodiment, a device includes a memory adapted to store first coordinates defining a first geographical location and information related to a deceased individual, a display device adapted to display images, and a camera adapted to obtain a first image of a second geographical location. The device also includes at least one processor adapted to determine second coordinates associated with the second geographical location, determine that the second coordinates match the first coordinates, generate an augmented image comprising the first image and a second image of a virtual tombstone associated with the deceased individual, and display the augmented image on the display device.

In one embodiment, the at least one processor is further adapted to determine third coordinates of a current geographical location of the device, and determine second coordinates associated with the second geographical location based on the third coordinates.

In another embodiment, the at least one processor is further adapted to determine the third coordinates of a current geographical location of the device based on GPS signals.

In another embodiment, the device includes a compass adapted to provide directional information. The at least one processor is further adapted to determine a distance between the device and the second geographical location, and determine the second coordinates associated with the second geographical location based on the third coordinates, the distance, and the directional information.

In another embodiment, the virtual tombstone comprises one of: an image of a tombstone, an image of a bust of the deceased individual, and a an image of a statue of the deceased individual.

In another embodiment, the at least one processor is further adapted to use an augmented reality technique to generate the augmented image.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein.

The breadth and scope of the present invention should not be limited by any of the above-described exemplary embodiments or any actual software code with the specialized control of hardware to implement such embodiments, but should be defined only in accordance with the following claims and their equivalents.

1. An electronic device for creating and displaying a virtual tombstone, comprising:
a processor in the electronic device;
a memory in the electronic device, communicatively coupled to the processor and configured to store one or more virtual tombstone objects, each virtual tombstone object comprising coordinate information and information related to a deceased individual, the coordinate information corresponding to a memorial area away from a fixed geographical location with remains of the deceased; and
a display component, communicatively coupled to the processor, configured to display images;
a camera component, communicatively coupled to the processor, configured to obtain a first image of a second geographical location;
wherein the processor is configured to:
receive first coordinates defining a first geographical location and identification information identifying a specified deceased individual;
create a virtual tombstone object based on the first coordinates and the identification information;
store the virtual tombstone object in the memory in the electronic device;
determine second coordinates associated with the second geographical location;
determine that the second coordinates match the first coordinates;
generate an augmented image comprising the first image and a second image of a virtual tombstone associated with the specified deceased individual; and
display the augmented image via the display component.

2. The system of claim 1, wherein the processor in the electronic device is further configured to:
determine third coordinates of a current geographical location of the system; and determine second coordinates associated with the second geographical location based on the third coordinates.

3. The system of claim 2, wherein the processor in the electronic device is further configured to:
determine the third coordinates of a current geographical location of the system based on GPS signals.

4. The system of claim 2, further comprising a compass component configured to provide directional information;
wherein the processor in the electronic device is further configured to:
determine a distance between the system and the second geographical location;
and determine the second coordinates associated with the second geographical location based on the third coordinates, the distance, and the directional information.

5. The system of claim 1 wherein the second image of a virtual tombstone comprises one of: an image of a tombstone, an image of a bust of the deceased individual, and an image of a statue of the deceased individual.

6. The system of claim 1, wherein the processor in the electronic device is further configured to:
use an augmented reality technique to generate the augmented image.

7. A system of generating and displaying a virtual tombstone using an electronic device comprising:
a processor in the electronic device;
a memory in the electronic device communicatively coupled to the processor and configured to store one or more virtual tombstone objects, each virtual tombstone object comprising coordinate information and information related to a deceased individual, the coordinate information corresponding to a memorial area away from a fixed geographical location with remains of the deceased; and
wherein the processor in the electronic device is configured to:
receive first coordinates defining a first geographical location and identification information identifying a specified deceased individual;
create a virtual tombstone object based on the first coordinates and the identification information;
store the virtual tombstone object in the memory in the electronic device;
determine second coordinates associated with a second geographical location associated with the electronic device;
determine that the second coordinates match the first coordinates;
generate an augmented image comprising the first image and a second image of a virtual tombstone associated with the deceased individual; and
cause the electronic device to display the augmented image.

8. The system of claim 7, wherein the processor in the electronic device is further configured to:
determine third coordinates of a current geographical location of the electronic device; and
determine the second coordinates based on the third coordinates.

9. The system of claim 8, wherein the processor in the electronic device is further configured to:
receive directional information from a global positioning system (GPS) component in the electronic device;
obtain distance information defining a distance between the electronic device and the second geographical location; and
determine the second coordinates associated with the second geographical location based on the third coordinates, the distance information, and the directional information.

10. The system of claim 7, wherein the second image of a virtual tombstone comprises one of: an image of a tombstone, an image of a bust of the deceased individual, and an image of a statue of the deceased individual.

11. The system of claim 7, wherein the processor in the electronic device is further configured to:
use an augmented reality technique to generate the augmented image.

12. The system of claim 7, wherein the processor is further configured to communicate with a second electronic device via a network.

13. The system of claim 12, wherein the processor is further configured to:
receive the first image from the second electronic device, via the network.

14. The system of claim 7, wherein the processor in the electronic device is further configured to:
store the augmented image;
generate a web page that includes the augmented image; and
provide, to a third electronic device, access to the web page.

15. The system of claim 7, wherein the processor in the electronic device is further configured to:
provide virtual tombstone services via the web page.

16. A method of generating and displaying a virtual tombstone using an electronic device comprising:
storing, in a memory of the electronic device, information associated with a deceased individual and coordinates defining a geographical location, the coordinate information corresponding to a memorial area away from a fixed geographical location with remains of the deceased;
obtaining, by a camera of the electronic device, a first image of the geographical location;
generating by the electronic device, an augmented image by adding a second image of a virtual tombstone associated with the deceased individual to the first image; and
displaying the augmented image on a display device of the electronic device.

17. The method of claim 16, further comprising:
determining, by the electronic device, second coordinates associated with a current geographical location of the electronic device;
determining, by the electronic device, third coordinates of the geographical location based on the second coordinates; and
determining, by the electronic device, that the third coordinates match the coordinates,

18. The method of claim 16, further comprising: determining the second coordinates based on GPS signals received by the electronic device.

19. The method of claim 16, wherein the virtual tombstone comprises one of: an image of a tombstone, an image of a bust of the deceased individual, and an image of a statue of the deceased individual.

20. The method of claim 16, further comprising:
using an augmented reality technique by the electronic device to generate the augmented image.
